(19) United States
(12) Patent Application Publication
(10) Pub. No.: US 2013/0175380 A1
(43) Pub. Date: Jul. 11, 2013

(54) CARTRIDGE TAPE AND DRIVE DEVICE

(71) Applicant: FUJITSU LIMITED, Kawasaki (JP)

(72) Inventor: Junichi SATO, Kawasaki (JP)

(73) Assignee: FUJITSU LIMITED, Kawasaki (JP)

(21) Appl. No.: 13/668,575

(22) Filed: Nov. 5, 2012

(30) Foreign Application Priority Data
Jan. 5, 2012 (JP) 2012-000574

(51) Int. Cl. G11B 19/20; G11B 23/107

(52) U.S. Cl. 242/340; 242/348

(57) ABSTRACT

A cartridge tape includes: a casing including a magnetic tape; and a reel hub disposed inside the casing; the reel hub includes: a cylindrical portion around which the magnetic tape is wound; and an annular multipolar magnet to rotate the reel hub when a rotating magnetic field is applied outside a wall of the casing.

### CROSS-REFERENCE TO RELATED APPLICATION(S)

This application is based upon and claims the benefit of priority of the prior Japanese Patent Application No. 2012-574, filed on Jan. 5, 2012, the entire contents of which are incorporated herein by reference.

### FIELD

The embodiments discussed herein are related to a cartridge tape and a drive device for the cartridge tape.

### BACKGROUND

A large-capacity external storage for use in large-scale computer equipment includes a library device. The library device contains many cartridges in each of which a magnetic tape medium is incorporated. The cartridge is conveyed to a tape drive by a conveying mechanism, and data is read from and written into the tape medium. The library device includes a plurality of tape drives or optical disk drives.

A reel hub around which a magnetic tape is wound is contained within a casing of a cartridge tape used in the library device. A leader pin is attached to a leading end of the magnetic tape, and the leader pin is positioned inside a tape outlet that is opened and closed by a door. A mechanism for opening and closing the door is called a shutter mechanism. The shutter mechanism has the dustproof function. When the cartridge is conveyed into the drive device, the door is opened and the magnetic tape is led out.

Related art is disclosed in Japanese Laid-open Patent Publication No. 11-339433.

### SUMMARY

According to one aspect of the embodiments, a cartridge tape includes: a casing including a magnetic tape; and a reel hub disposed inside the casing; the reel hub includes: a cylindrical portion around which the magnetic tape is wound; and an annular multipolar magnet to rotate the reel hub when a rotating magnetic field is applied outside a wall of the casing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates an exemplary cartridge tape;

FIG. 1B illustrates an exemplary label;

FIG. 1C is an exemplary exploded perspective view of a cartridge tape;

FIGS. 2A and 2B illustrate an exemplary drive device;

FIG. 3 illustrates an exemplary cartridge tape;

FIGS. 4A and 4B illustrate an exemplary cartridge tape;

FIGS. 5A to 5D illustrate an exemplary cartridge tape;

FIGS. 6A and 6B illustrate an exemplary reel motor;

FIGS. 7A and 7B illustrate an exemplary tape outlet;

FIG. 8A illustrates an exemplary door; and

FIG. 8B illustrates an exemplary tape outlet.

### DESCRIPTION OF EMBODIMENTS

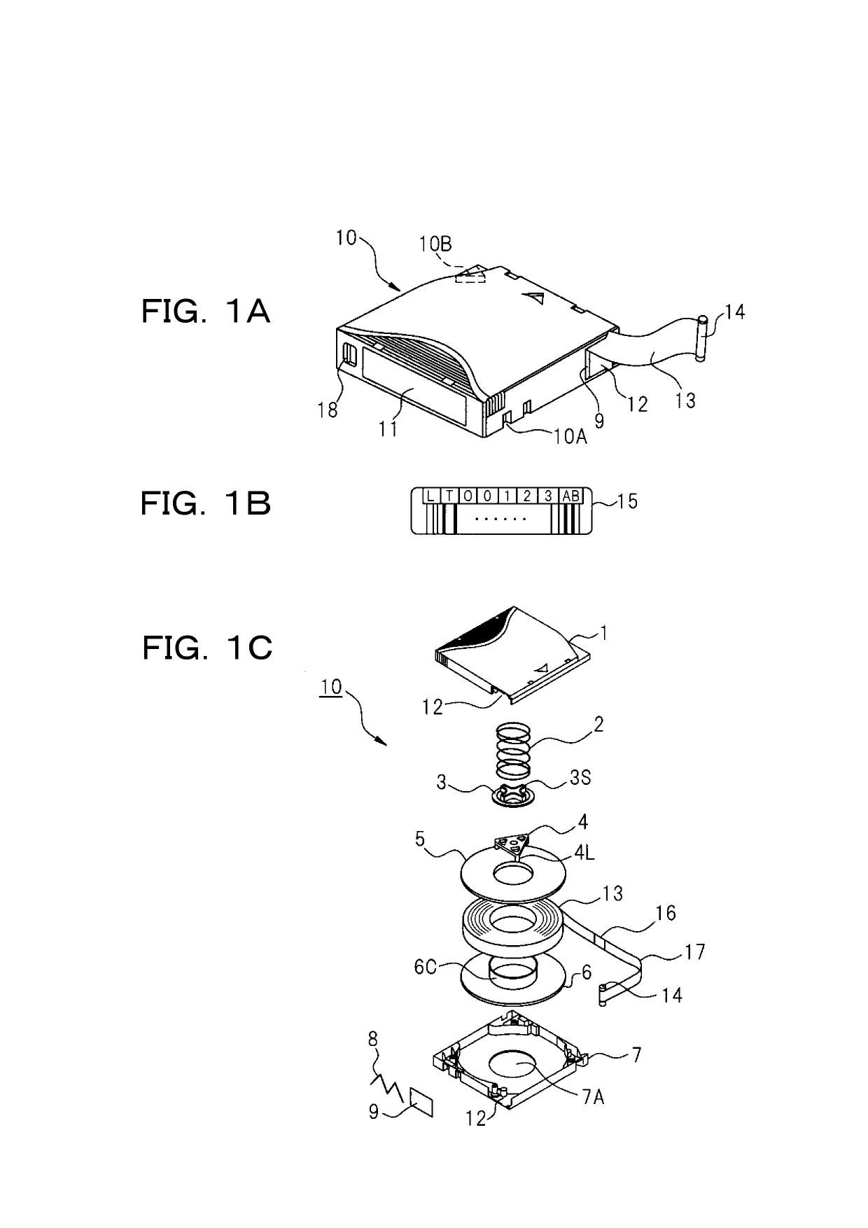

FIG. 1A illustrates an exemplary cartridge tape. FIG. 1A may illustrate an external appearance of a Linear Tape Open (LTO) cartridge tape 10 used in a library device. The LTO cartridge tape 10 may be called a “cartridge tape 10” hereinafter. A reel hub around which a magnetic tape 13 is wound is contained in the cartridge tape 10. A leader pin 14 is attached to a leading end of the magnetic tape 13. The magnetic tape 13 is led out through a tape outlet 12, which is formed in one lateral surface of the cartridge tape 10, under guiding by the leader pin 14. The tape outlet 12 is provided with a door 9. When the magnetic tape 13 is not used, the tape outlet 12 is closed, thereby reducing an intrusion of dusts into the cartridge tape 10. The storage capacity of the cartridge tape 10 may differ depending on specifications and may be, e.g., 100 to 1500 GB.

FIG. 1B illustrates an exemplary label. In addition to the tape outlet 12, an identification label pasted region 11, a recess 10A, a lock slot 10B, and a write protect switch 18 are provided in the lateral surfaces of the cartridge tape 10. For example, a barcode label 15 including a barcode printed thereon, illustrated in FIG. 1B, is pasted to the identification label pasted region 11. The label pasted to the identification label pasted region 11 may include a label on which a two-dimensional barcode is printed, or a label on which a mark or a symbol is printed. The recess 10A may be provided such that a hand of a robot for conveying the cartridge tape 10 inside the library device is inserted to the recess 10A. The lock slot 10B may be provided to fixedly hold the cartridge tape 10 when the cartridge tape 10 is contained in a cartridge magazine.

FIG. 1C illustrates an exemplary exploded perspective view of a cartridge tape. FIG. 1C may illustrate the interior of the cartridge tape 10 illustrated in FIG. 1A. A reel spring 2, a reel lock 3, a spider 4, a flange 5, a reel hub 6, and the magnetic tape 13 wound around the reel hub 6 are disposed in a space sandwiched between an upper shell 1 and a lower shell 7, these shells corresponding to the casing. A leader tape 17 is coupled to a leading end portion of the magnetic tape 13 via a splicing tape 16. The leader pin 14 for leading out the magnetic tape 13 is attached to a leading end of the leader tape 17.

A spring receiver for receiving an upper end portion of the reel spring 2 and a projection for fitting with a stopper 3S to stop rotation of the reel lock 3, the stopper 3S being protruded on an upper surface of the reel lock 3, are provided on an inner wall surface of the upper shell 1. The projection may have a crossed shape in a horizontal section. A lower end portion of the reel spring 2 is positioned around the stopper 3S on the reel lock 3. Near an outer periphery of a lower surface of the reel lock 3, a checking gear is provided to be engaged with a checking projection, which is provided on the reel hub 6, thereby locking rotation of the reel hub 6.

The reel hub 6 includes a cylindrical portion 6C at a central portion thereof. The magnetic tape 13 may be wound around the cylindrical portion 6C. The flange 5 attached to an upper end of the cylindrical portion 6C may keep the magnetic tape 13, which is wound around the reel hub 6, from slipping off from the reel hub 6. On a bottom surface of the cylindrical portion 6C, the checking projection is provided to be engaged with the checking gear, which is provided on the lower surface of the reel lock 3, thereby locking rotation of the reel hub 6. The checking gear provided on the lower surface of the reel lock 3 may be provided to extend over an entire circumference of the lower surface of the reel lock 3 near the outer periphery thereof. The checking projection for locking rotation of the reel hub 6 may be not provided in a state extending over an entire circumference of the bottom surface of the cylindrical portion 6C.

The spider 4 and the reel lock 3 are inserted inside the cylindrical portion 6C that is provided in the central portion of the reel hub 6. A ring-shaped gear is provided on a rear surface of the reel hub 6. The gear is disposed within a hole 7A that is formed in a central portion of the lower shell 7. The door 9 for opening and closing the tape outlet 12 is attached to, in a state biased by a door spring 8, the tape outlets 12 that are provided at substantially the same height of the side surfaces of the upper shell 1 and the lower shell 7. In FIG. 1C, components, such as an anti-abrasion member and a noncontact memory device, may be omitted. Screws for screwing the upper shell 1 and the lower shell 7 may be omitted in FIG. 1C.

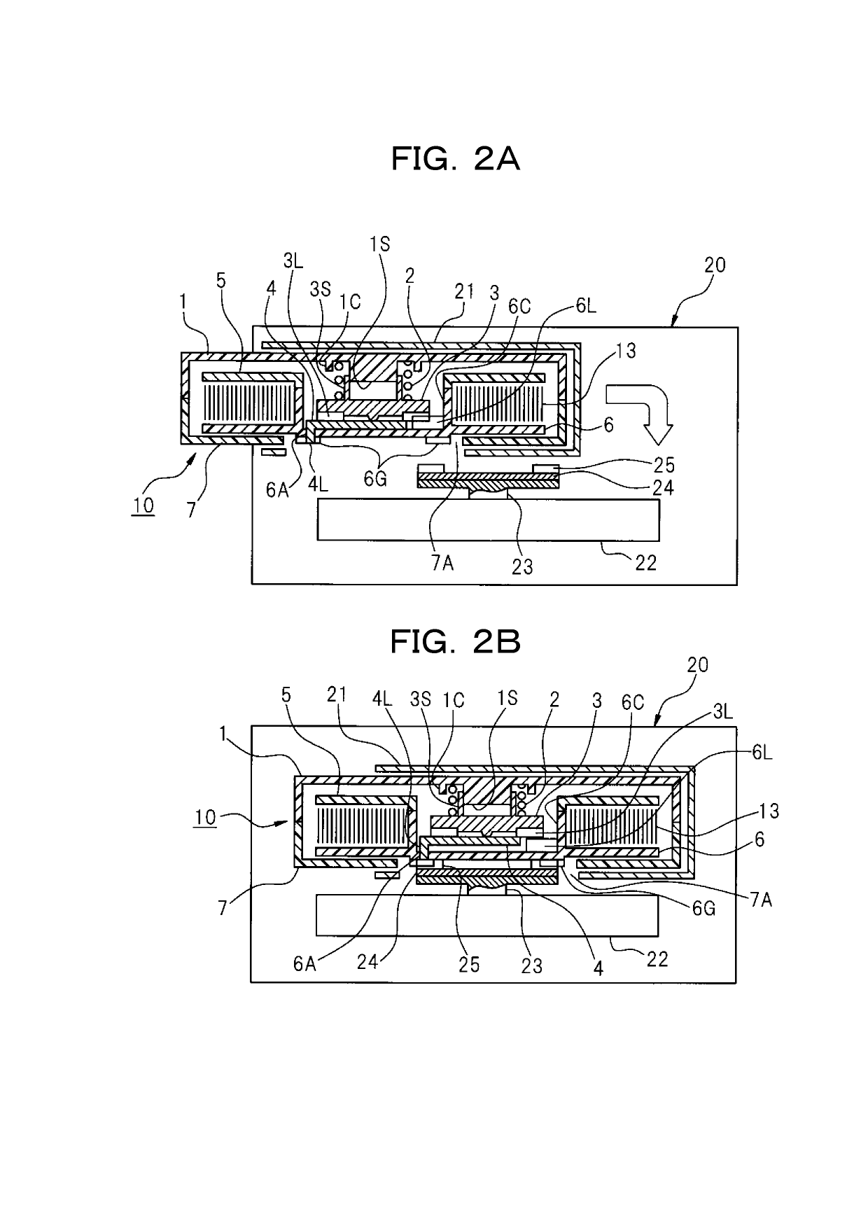

FIGS. 2A and 2B illustrate an exemplary drive device. In FIG. 2A, the cartridge tape 10, illustrated in FIG. 1, may be inserted into a loader mechanism 21 of a tape drive 20 in a drive device including a library device. The cartridge tape 10 may be in a state not engaged with a reel motor 22 disposed within the tape drive 20. When the cartridge tape 10 is inserted into the loader mechanism 21, the loader mechanism 21 moves the cartridge tape 10 within the tape drive 20 in the horizontal direction. Upon the cartridge tape 10 reaching a certain position within the tape drive 20, the loader mechanism 21 descends the cartridge tape 10, thus causing the cartridge tape 10 to be placed on the reel motor 22. In FIG. 2B, the cartridge tape 10 is placed on the reel motor 22 within the tape drive 20.

For example, as illustrated in FIG. 2A, the spring receiver 1C for receiving the upper end portion of the reel spring 2 and the projection 1S for fitting with the stopper 3S, the stopper 3S being protruded on the upper surface of the reel lock 3, are provided on the inner wall surface of the upper shell 1. The projection 15 may have a crossed shape in a horizontal section. The projection 15 is fitted into the stopper 3S, and the stopper 3S is locked to be not rotated relative to the projection 15. The lower end portion of the reel spring 2 is positioned around the stopper 3S of the reel lock 3, thus biasing the reel lock 3 toward the lower shell 7.

The spider 4 and the reel lock 3, both inserted inside the cylindrical portion 6C of the reel hub 6, are biased by the reel spring 2 and are pressed against the bottom surface of the cylindrical portion 6C of the reel hub 6. In the biased state, the checking gear 3L provided near the outer periphery of the lower surface of the reel lock 3 is engaged with the checking projection 6L that is provided on the bottom surface of the cylindrical portion 6C of the reel hub 6. Therefore, the reel hub 6 is not rotated even when the reel hub 6 is caused to rotate through a hole 7A in the lower shell 7.

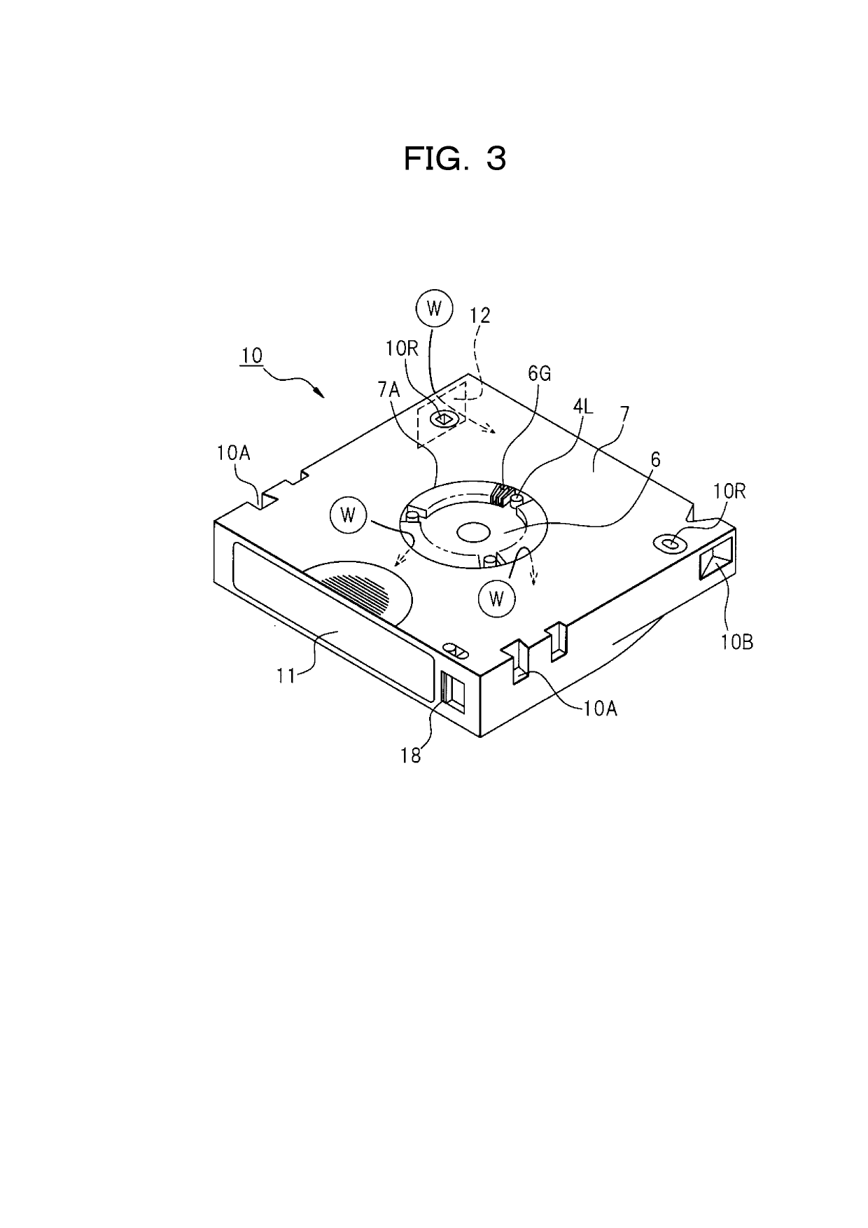

The spider 4 may be, e.g., a triangular plate-like member with legs 4L projecting from its lower surface at three apexes, as illustrated in FIG. 1C. The three legs 4L are inserted respectively through holes 6A formed in a lower surface of the reel hub 6 and are positioned to project into portions where the gear 6G is not present (see FIG. 3). The shape of the spider 4 and the number of the legs 4L projecting from the lower surface of the spider 4 may be optionally selected. A flange-like fitting member 24 is mounted to a rotating shaft 23 of the reel motor 22 that is installed in the tape drive 20. A ring-shaped drive gear 25 is provided on the flange-like fitting member 24. The drive gear 25 is meshed with the gear 6G projecting from the lower surface of the reel hub 6, whereby the reel hub 6 is rotated.

When the cartridge tape 10 is descended by the loader mechanism 21 and the cartridge tape 10 is placed on the reel motor 22, the drive gear 25 of the reel motor 22 is meshed with the gear 6G projecting from the lower surface of the reel hub 6. Upon the drive gear 25 meshing with the gear 6G of the reel hub 6, the three legs 4L of the spider 4, projecting into the portions where the gear 6G is not present, are each pressed by the drive gear 25.

With the three legs 4L of the spider 4 being each pressed by the drive gear 25, the spider 4 is moved upwards to press the reel lock 3 positioned on the spider 4. The reel lock 3 pressed by the spider 4 is ascended while compressing the reel spring 2, whereby the spider 4 is also ascended. Therefore, the checking gear 3L provided on the lower surface of the reel lock 3 is disengaged from the checking projection 6L that is provided on the bottom surface of the cylindrical portion 6C of the reel hub 6. In that state, because the reel hub 6 is not locked by the reel lock 3, the reel hub 6 is rotated by the drive gear 25 of the reel motor 22.

The cartridge tape 10 may be used for the purpose of an archive in addition to backup of computer equipment. When the cartridge tape 10 is used for the purpose of an archive, a large number of cartridge tapes may be incorporated in the library device, and desired one of the cartridge tapes may be extracted by a robot.

FIG. 3 illustrates an exemplary cartridge tape. For example, in the event that the cartridge tape 10 or the library device is submerged, water, seawater or sludge may enter the cartridge tape 10. As illustrated in FIG. 3, a foreign matter W, such as water, seawater or sludge, may enter the cartridge tape 10 through the hole 7A in the lower shell 7 of the cartridge tape 10 and a clearance around the door 9 for the tape outlet 12. If sludge enters the cartridge tape 10 and adheres to the magnetic tape 13, a difficulty may arise in cleaning the magnetic tape 13, which has a length over several hundred meters per tape, without damaging the magnetic tape 13.

When the write protect switch 18 slidable to the left and the right, illustrated in FIG. 3, is slid to the right in the drawing, a write protect state (write inhibit) is set. With the presence of an inner wall on the inner side, the foreign matter W may not enter the cartridge tape 10 through the write protect switch 18.

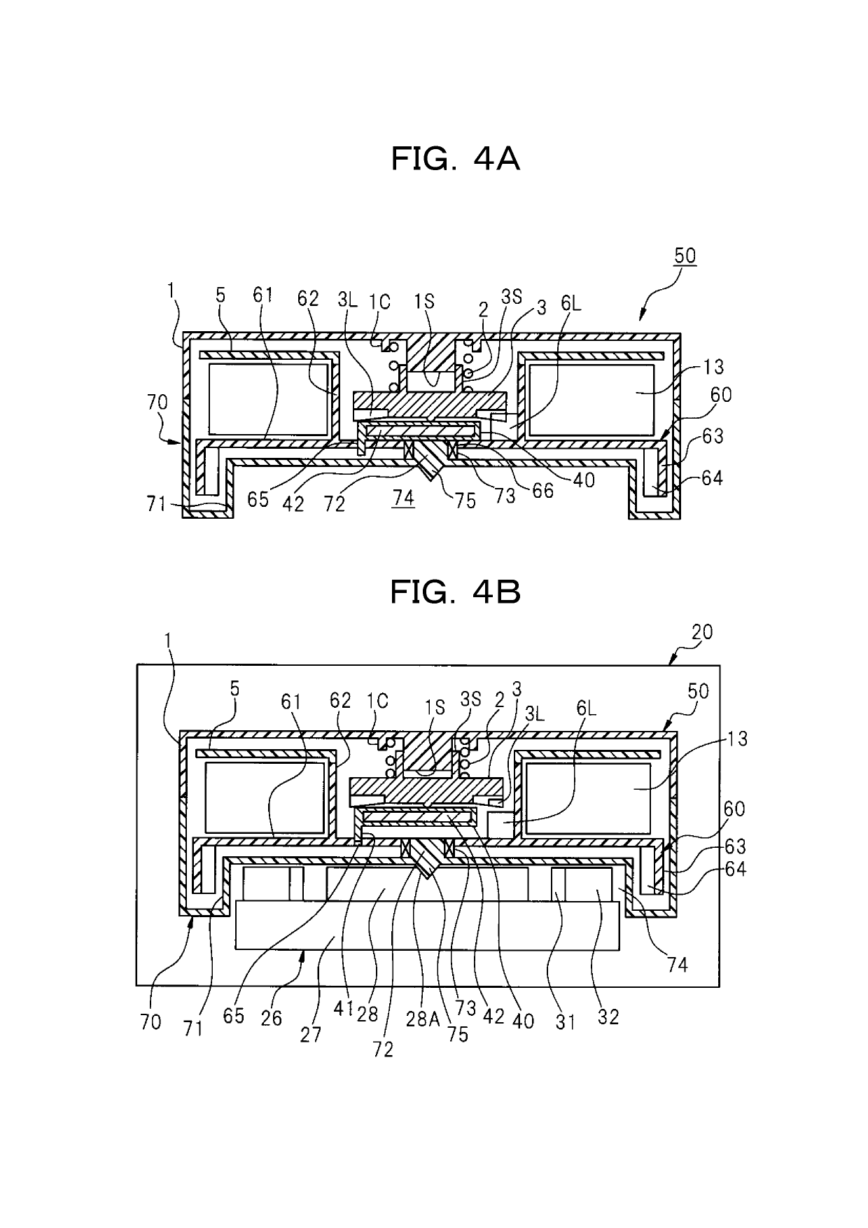

FIGS. 4A and 4B illustrate an exemplary cartridge tape. Description of elements in FIGS. 4A and 4B, which are substantially the same as or similar to those illustrated in FIG. 1C, may be omitted or reduced while those elements are denoted by the same symbols.

In FIG. 4A, a cartridge tape 50 is not inserted in a cartridge drive. The cartridge tape 50 includes an upper shell 1 and a lower shell 70 both corresponding to a casing. At joined portions of the upper shell 1 and the lower shell 70, joined portions of respective walls partitioning the inside and the outside of the cartridge tape 50 may have a known waterproof joining structure. The waterproof joining structure may include, e.g., a structure in which the joined portions of the upper shell 1 and the lower shell 70 are joined to each other in a watertight manner, or a structure in which the joined portions are joined to each other with a sealing rubber (packing) fitted therebetween.

In a space sandwiched between the upper shell 1 and the lower shell 70, there are disposed a reel spring 2, a reel lock 3, a spider 40, a flange 5, a reel hub 60, and a magnetic tape 13 wound around the reel hub 60. For example, as illustrated in FIG. 1C, a leader tape may be coupled to a leading end portion of the magnetic tape 13 via splicing tape. A leader pin for leading out the magnetic tape 13 may be attached to a leading end of the leader tape. The leader tape, the splicing tape, and the leader pin may be omitted in FIGS. 4A and 4B.

A spring receiver 1C for receiving an upper end portion of the reel spring 2 and a projection 1S for fitting with a stopper 3S, the stopper 3S being protruded on an upper surface of the reel lock 3, are provided on an inner wall surface of the upper shell 1. The projection 15 is fitted into the stopper 3S, and the stopper 3S is locked to be not rotated relative to the projection 1S. The lower end portion of the reel spring 2 is positioned around the stopper 3S of the reel lock 3, thus biasing the reel lock 3 toward the lower shell 70. Near an outer periphery of a lower surface of the reel lock 3, a checking gear 3L is provided to be engaged with a checking projection 6L, which is provided on the reel hub 60, thereby locking rotation of the reel hub 60. Constructions of the upper shell 1, the reel spring 2, the reel lock 3, the flange 5, and the magnetic tape 13, all illustrated in FIGS. 4A and 4B, may be substantially the same as or similar to those illustrated in FIG. 1C.

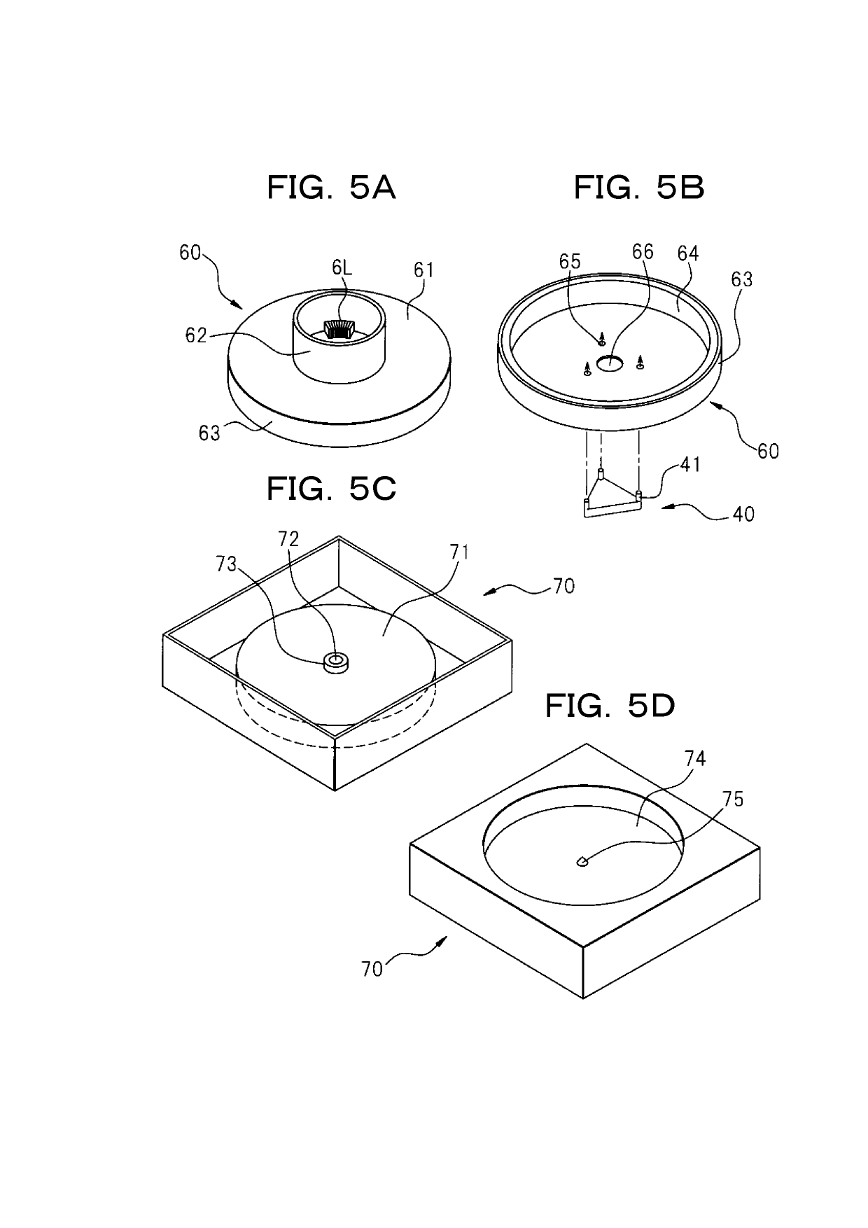

FIGS. 5A to 5D illustrate an exemplary cartridge tape. A cylindrical portion 62 is provided on an upper surface 61 of the reel hub 60 in a central portion thereof, and the magnetic tape 13 is wound around the cylindrical portion 62. A structure of the flange 5 attached to an upper end of the cylindrical portion 62 may be substantially the same as or similar to that illustrated in FIG. 1C. On a bottom surface of the cylindrical portion 62, the checking projection 6L is provided to be engaged with the checking gear 3L, which is provided on the lower surface of the reel lock 3, thereby locking rotation of the reel hub 60. The checking projection 6L is provided on the bottom surface of the cylindrical portion 62 at predetermined intervals.

The spider 40 and the reel lock 3, both inserted inside the cylindrical portion 62 of the reel hub 60, are biased by the reel spring 2 and are pressed against the bottom surface of the cylindrical portion 62 of the reel hub 60, the bottom surface being, e.g., the same as an upper surface 61 of the reel hub 60. In the biased state, the checking gear 3L provided near the outer periphery of the lower surface of the reel lock 3 is engaged with the checking projection 6L that is provided on the bottom surface of the cylindrical portion 62. Therefore, the reel hub 60 is not rotated.

The spider 40 may be, e.g., a triangular plate-like member with legs 41 projecting from its lower surface at three apexes, as illustrated in FIG. 5B (representing a vertically reversed state). A permanent magnet 42 may be embedded in the spider 40, as illustrated in FIG. 4A. Alternatively, the spider 40 may be entirely formed of a permanent magnet. The permanent magnet 42 may be polarized in the vertical direction, e.g., in the direction in which the spider 40 ascends and descends, or in the axial direction of a yoke member (described later). For example, when a portion of the permanent magnet 41 on the side closer to the reel lock 3 has an S pole, a portion of the permanent magnet 41 on the side closer to the reel hub 60 has an N pole. As illustrated in FIG. 5B, the three legs 41 are inserted through spider-leg insertion holes 65, respectively, which are formed to penetrate through the reel hub 60 from an upper surface to a lower surface thereof, such that the three legs 41 project from the lower surface of the reel hub 60. The number of the legs 41 projecting from the lower surface of the spider 40 may be optionally selected.

As illustrated in FIGS. 5A and 5B, an outer peripheral portion of an upper surface 61 of the reel hub 60 is extended toward the lower shell 70 and includes a skirt 63 serving as a mounting portion to which a magnet is mounted. An annular permanent magnet 64 is attached to an inner peripheral surface of the skirt 63. The annular permanent magnet 64 has a multipolar permanent magnet structure in which an N pole and an S pole are alternately formed at predetermined intervals along an inner peripheral surface of the annular permanent magnet 64. The annular permanent magnet 64 may be called an annular multipolar magnet 64. Instead of the annular multipolar magnet 64, an even number of magnets may be attached side by side to the inner peripheral surface of the skirt 63 such that poles of the adjacent magnets are alternately reversed on each of the inner side and the outer side. The intensity of magnetization of the annular multipolar magnet 64 may be set to such an extent that the reel hub 60 can be rotated with a rotating magnetic field applied from an electromagnet, which is disposed on the tape drive side, without affecting the magnetized state of the magnetic tape 13. A bearing mount hole 66 penetrating through the reel hub 60 from the upper surface to the lower surface thereof is formed in a central portion of the reel hub 60. A bearing is mounted to the bearing mounting hole 66.

As illustrated in FIGS. 5C and 5D (representing a vertically reversed state), the lower shell 70 may have a rectangular box-like shape opened on the upper side. A central portion of a bottom surface of the lower shell 70 is recessed in a circular shape toward the inner side (upper surface side) from the outer side (lower surface side) such that a circular columnar portion 71 is formed on the inner side and a circular recess 74 is formed on the outer side. The diameter of the circular columnar portion 71 may be less than that of the reel hub 60. When the reel hub 60 is placed on the circular columnar portion 71, the skirt 63 of the reel hub 60 may be positioned between an outer periphery of the circular columnar portion 71 and an outer wall of the lower shell 70.

The difference between the diameter of the circular columnar portion 71 and the diameter of the circular recess 74 may be a difference corresponding to a wall thickness of the circular columnar portion 71. The difference between the depth of the circular recess 74 and the height of the circular columnar portion 71 may be a difference corresponding to a wall thickness of a top wall of the circular columnar portion 71. A reel hub mounting shaft 72 is provided to project from a center of a top surface of the circular columnar portion 71, and a bearing 73, e.g., a ball bearing, is attached around the reel hub mounting shaft 72. A triangular pyramid-shaped projection 75 is provided at a center of the circular recess 74.

The reel hub 60 is mounted onto the lower shell 70 with the bearing mounting hole 66 fitted to the bearing 73 that is provided on the lower shell 70. In that state, as illustrated in FIG. 4A, the skirt 63 of the reel hub 60 is positioned to extend in a space between the outer wall of the lower shell 70 and the circular columnar portion 71. Therefore, the height of the skirt 63 of the reel hub 60 may be smaller than that of the circular columnar portion 71, and the inner diameter of the permanent magnet 64 attached to the inner peripheral surface of the skirt 63 may be larger than the outer diameter of the circular columnar portion 71.

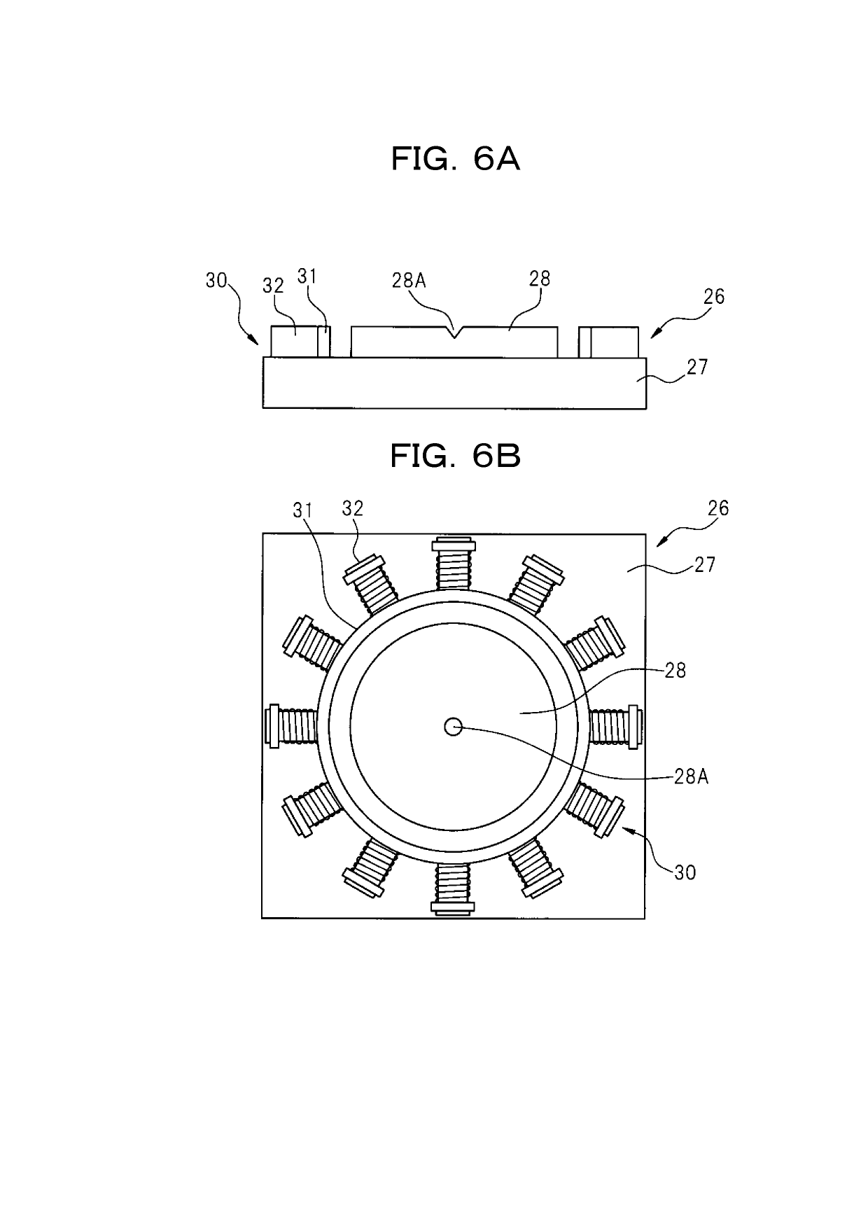

FIGS. 6A and 6B illustrate an exemplary reel motor. The reel motor 26 illustrated in FIGS. 6A and 6B may be installed inside a tape drive 20 to drive the cartridge tape 50. The reel motor 26 may be a blushless motor without including a rotor structure. A control circuit includes a disk-shaped permanent magnet 28 installed on a embedded base 27, and a rotating magnetic field generator 30 installed outside the permanent magnet 28. A triangular pyramid-shaped engagement recess 28A is formed at a center of the permanent magnet 28. The permanent magnet 28 is polarized in the vertical direction and has polarities that are reversed to the polarities of the permanent magnet 42 built in the spider 40. For example, when the polarity of the permanent magnet 42 built in the spider 40 is an S pole on the side closer to the reel hub 60, the polarity of the permanent magnet 28 may be an S pole on the side closer to the reel hub 60. The intensity of magnetism of the permanent magnet 28 may be set to such an extent as allowing the reel lock 3 to be released without affecting the magnetized state of the magnetic tape 13. The rotation speed of the reel hub 60 is detected using a Hall device.

The rotating magnetic field generator 30 includes an electromagnet mounting ring 31 that serves as the yoke member, and a plurality of electromagnets 32 mounted in a radial pattern to the outer side of the electromagnet mounting ring 31. The respective heights of the permanent magnet 28, the electromagnet mounting ring 31, and the electromagnets 32 from the base 27 may be substantially comparable to each other. One end of coils wound over the plural electromagnets 32 is coupled to the control circuit built in the base 27. When the electromagnets 32 installed on the electromagnet mounting ring 31 are successively energized clockwise or counterclockwise by the control circuit, a rotating magnetic field is generated outside the electromagnets 32. The intensity of a magnetic force (electromagnetic force) generated from the electromagnets 32 may be set to such an extent as enabling the reel hub 60 to rotate without affecting the magnetized state of the magnetic tape 13.

When the cartridge tape 50 is inserted into the tape drive 20, the cartridge tape 50 is moved in the horizontal direction and then descended by a loader mechanism (not illustrated) to be placed on the reel motor 26. In the state where the cartridge tape 50 is placed on the reel motor 26, the engagement projection 75 projecting in the circular recess 74 of the lower shell 70 is received in the engagement recess 28A of the permanent magnet 28 mounted on the base 27 of the reel motor 26. With the engagement of the engagement recess 28A and the engagement projection 75, a center of the reel motor 26 is aligned with a center of rotation of the reel hub 60.

When the cartridge tape 50 is placed on the reel motor 26 within the tape drive 20, the permanent magnet 42 built in the spider 40 and the permanent magnet 28 mounted on the base 27 of the reel motor 20 are positioned such that their surfaces including the same polarity are opposed to each other, whereby a repulsive force is generated. The repulsive force generated between the permanent magnet 28 and the permanent magnet 42 causes the spider 40 to float from the upper surface 61 of the reel hub 60, thus pushing up the reel lock 3. Because the three legs 41 of the spider 40 are moved respectively in the spider-leg insertion holes 65, the reel lock 3 is vertically pushed up without being rotated.

The reel lock 3 pushed up by the spider 40 is ascended while compressing the reel spring 2. With the ascent of the reel lock 3, the checking gear 3L provided on the lower surface of the reel lock 3 is disengaged from the checking projection 6L that is provided on the bottom surface of the cylindrical portion 62 of the reel hub 60. In that state, because the reel hub 60 is not locked by the reel lock 3, the reel hub 60 is rotatable relative to the reel hub mounting shaft 72 that is projected from the bottom surface of the lower shell 70.

In the state where the cartridge tape 50 is placed on the reel motor 26 within the tape drive 20, the electromagnets 32 installed on the base 27 are positioned to face the annular multipolar magnet 64 that is mounted to the inner peripheral surface of the skirt 63 of the reel hub 60. When the electromagnets 32 installed on the base 27 are successively energized, the reel motor 26 generates the rotating magnetic field. Since the annular multipolar magnet 64 follows the rotating magnetic field, the reel hub 60 is rotated about the reel hub mounting shaft 72 serving as a rotation shaft. The bearing (ball bearing) 73 disposed between the reel hub mounting shaft 72 and the bearing mount hole 66 of the reel hub 60 smoothes the rotation of the reel hub 60.

The bottom surface of the lower shell 70 of the cartridge tape 50 does not have the hole 7A formed in the bottom surface of the cartridge tape 10, and the joined portions of the upper shell 1 and the lower shell 70 have a waterproof structure. Therefore, intrusion of foreign matters, e.g., water and sludge, into the inside of the cartridge tape 50 from the outside may be reduced. As in the cartridge tape 10, until the cartridge tape 50 is placed on the reel motor 27, the reel hub 60 is kept locked by the reel lock 3 and the reel hub 60 is not rotated.

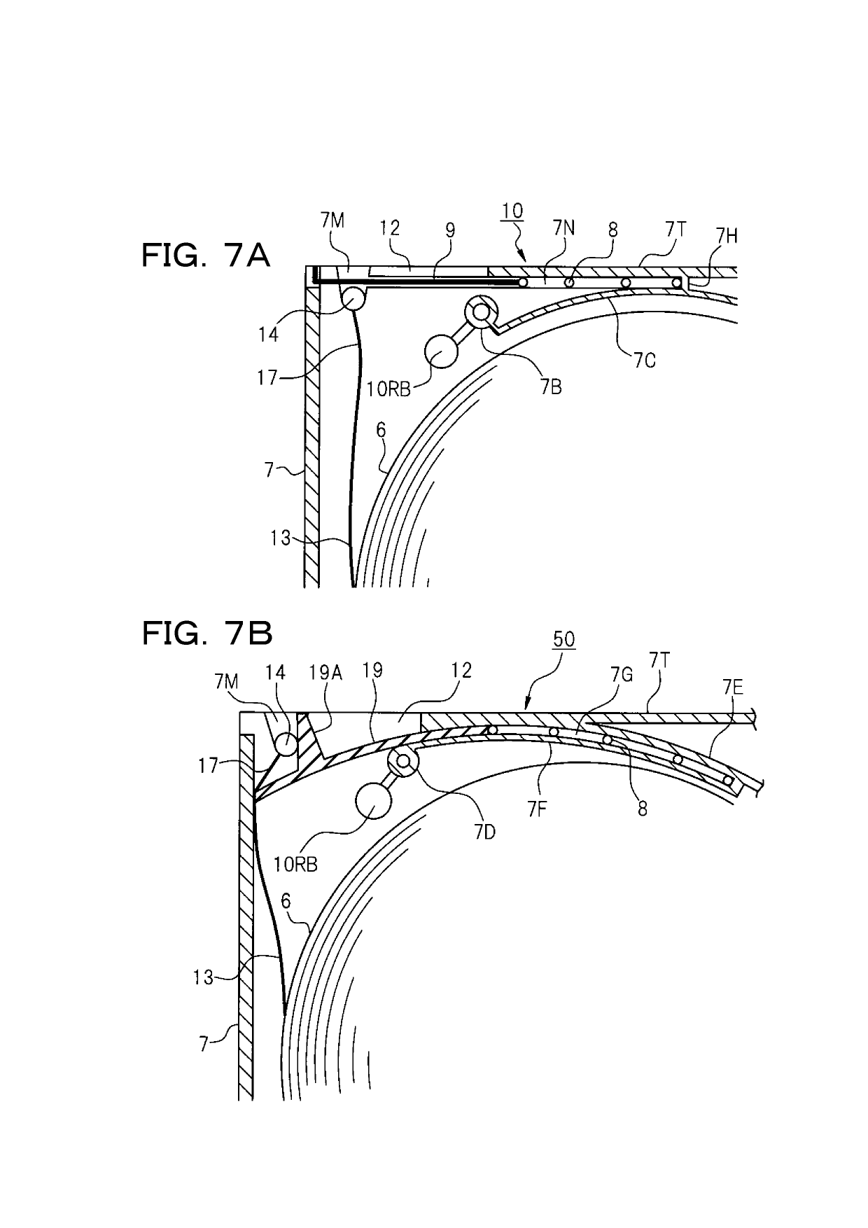

FIGS. 7A and 7B illustrate an exemplary tape outlet. While FIG. 7A illustrates the shape of the lower shell 7, the upper shell 1 having a similar shape is disposed on the lower shell 7.

The tape outlet 12 of the cartridge tape 10 may be an opening that is formed by cutting a part of an outer wall 7T of the lower shell 7. The tape outlet 12 includes a groove 7M for positioning of the leader pin 14, and a guide groove 7N along which the door 9 slides for opening and closing the tape outlet 12. When the tape outlet 12 is closed by the door 9, the leader pin 14 positioned in the groove 7M is located inside the door 9. The leader tape 17 is coupled to the leader pin 14, and the magnetic tape 13 coupled to the leader tape 17 is wound around the reel hub 6.

An inner wall 7C curving along the outer shape of the reel hub 6 is disposed inside the outer wall 7T of the lower shell 7 including the tape outlet 12. A connecting wall 7H is provided at a certain position between the inner wall 7C and the outer wall 7T. A door spring 8 is inserted between the connecting wall 7H and the door 9 such that the door 9 is held by the door spring 8 in a state closing the tape outlet 12. A boss 7B is formed at a free end of the inner wall 7C on the side closer to the tape outlet 12. A screw is inserted through the boss 7B, and the upper shell 1 and the lower shell 7 are joined to each other by the screw. Near the boss 7B, a projection 10RB may be formed corresponding to the back side of a reference hole 10R, illustrated in FIG. 3, formed in the LTO cartridge tape 10. The position of the projection 10RB corresponding to the back side of the reference hole 10R is in accordance with the LTO standards, and it may not be optionally changed. However, the positions of the boss 7B and the inner wall 7C may be changed.

FIG. 7B may illustrate a waterproof mechanism for a tape outlet 12 of the cartridge tape 50. In FIG. 7B, the tape outlet 12 is closed. The size of the tape outlet 12 may be substantially the same as that of the tape outlet 12 of the cartridge tape 10, which is formed by cutting a part of the outer wall 7T of the lower shell 7. The position of a groove 7M formed in the tape outlet 12 for positioning of the leader pin 14 and the position of a projection 10RB corresponding to the back side of an LTO reference hole 10R may be substantially the same as those in the cartridge tape 10.

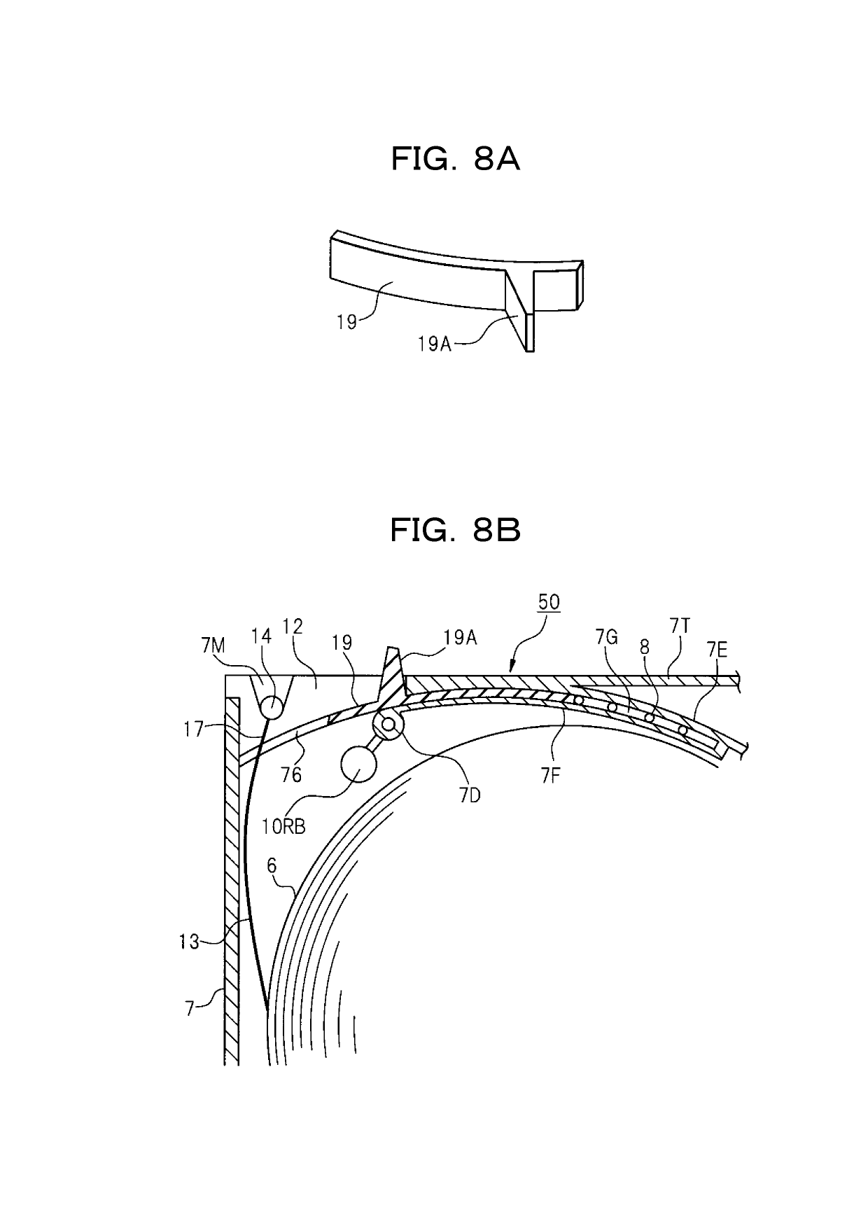

FIG. 8A illustrates an exemplary door. The door 19 in the form of a curved plate including a hard rubber member, illustrated in FIG. 8A, is disposed inside the outer wall 7T including the tape outlet 12. The door 19 may be finished with water repellent treatment. A lever 19A for allowing the door 19 to move from the outside is disposed to project from the door 19 at a position near the end on the side closer to the leader pin 14 of the door 19. When the tape outlet 12 is closed by the door 19, the leader pin 14 positioned in the groove 7M is located outside the door 19.

A circular arc slide groove 76, illustrated in FIG. 8B, is formed, for example, in each of respective inner surfaces of the upper shell 1 and the lower shell 70 inside the tape outlet 12. A first inner wall 7E and a second inner wall 7F, each curving in a circular arc shape, are provided inside the outer wall 7T, and a curved shutter box 7G is formed between the first inner wall 7E and the second inner wall 7F. The slide groove 76 and the shutter box 7G may be positioned on substantially the same circumference. A tailing end portion of the door 19 is contained in the shutter box 7G, and a waterproof structure is provided between the shutter box 7G and the door 19 contained therein. When the door 19 is closed, a waterproof state is also maintained between the door 19 and each of the inner surfaces of the upper shell 1 and the lower shell 70. An end of the first inner wall 7E is coupled to the outer wall 7T, while one end of the second inner wall 7F is coupled to the boss 7D and the other end thereof is coupled to the first inner wall 7E. A door spring 8 is inserted within the shutter box 7G such that the door 19 holds the tape outlet 12 in the closed state with the door spring 8.

When the tape outlet 12 is closed by the door 19, the leader pin 14 positioned in the groove 7M is located outside the door 19, and a leading end of the door 19 presses the leader tape 17, which is coupled to the leader pin 14, against the inner surfaces of the upper shell 1 and the lower shell 70. Accordingly, in the closed state of the door 19, a waterproof state is maintained between the leading end of the door 19 and each of the inner surfaces of the upper shell 1 and the lower shell 70.

With the structure of the tape outlet 12, a waterproof state is maintained between the door 19 and the upper shell 1 and between the door 19 and the lower shell 70 when the door 19 is in the closed state. In the closed state of the door 19, therefore, intrusion of foreign matters, such as water and sludge, into the inside of the cartridge tape 50 from the outside may be reduced due to the waterproof structure of the cartridge tape 50.

FIG. 8B illustrates an exemplary tape outlet 12. FIG. 8B illustrates the state where the door 19 is opened in the cartridge tape 50 illustrated in FIG. 7B. In the opened state of the door 19, the lever 19A of the door 19 is positioned at an end of the tape outlet 12, and a most part of the door 19 is contained in the shutter box 7G between the first inner wall 7E and the second inner wall 7F. In that state, the leader pin 14 is led out from the outside, and the magnetic tape 13 is led out of the cartridge tape 50.

By recessing the bottom surface of the lower shell 70 in a circular shape into the inner side from the outer side, the circular columnar portion 71 may be formed on the inner side, and the circular recess 74 may be formed on the outer side. The skirt 63 may be formed at an outer peripheral portion of the reel hub 60, and the annular multipolar magnet 64 may be mounted to the inner peripheral surface of the skirt 63. Alternatively, the bottom surface of the lower shell 70 may be flat. In such a case, an annular multipolar magnet may be mounted to the lower side of the outer peripheral portion of the reel hub 60 in an orientation to face the bottom surface of the lower shell 70, and electromagnets mounted to the electromagnet mounting ring 31 of the reel motor 26 may be positioned to face upwards.

A cartridge tape having high sealing performance and a tape drive suitable for the cartridge tape are provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cartridge tape comprising:
a casing including a magnetic tape; and
a reel hub disposed inside the casing;
the reel hub includes:
a cylindrical portion around which the magnetic tape is wound; and
an annular multipolar magnet to rotate the reel hub when a rotating magnetic field is applied outside a wall of the casing.

2. The cartridge tape according to claim 1, wherein the casing includes a recess provided at a central portion of a bottom surface of the casing so as to form a circular columnar portion at the inner side and a circular recess at the outer side, and
the reel hub includes, at a position opposed to an outer peripheral surface of the circular columnar portion, a mounting portion to which the annular multipolar magnet is mounted.

3. The cartridge tape according to claim 1, further comprising a locking mechanism, provided between an upper inner wall surface of the casing and an upper surface of the reel hub, to lock the reel hub.

4. The cartridge tape according to claim 3, wherein the locking mechanism includes:
a reel locking member to be vertically movable relative to the upper inner wall surface at a horizontally certain position and engage with the reel hub at a position away from the upper inner wall surface;
a biasing member to bias the reel locking member in a direction away from the upper inner wall surface; and
a lock releasing member disposed between the reel locking member and the upper surface of the reel hub.

5. The cartridge tape according to claim 4, wherein the lock releasing member includes a permanent magnet to move the reel locking member toward the upper inner wall surface by a magnetic force, which is applied from the reel hub side, and to release the engagement of the reel locking member and the reel hub.

6. The cartridge tape according to claim 1, wherein the casing includes:
an upper shell;
a lower shell;
a first waterproof structure provided at a joined portion of the upper shell and the lower shell; and
a second waterproof at a portion of a door member to open and close a tape outlet for leading out the magnetic tape from the casing, the portion of the door member being contacted with an inner surface of the upper and lower shells.

7. The cartridge tape according to claim 2, wherein the mounting portion includes a skirt, provided at an outer peripheral portion of the reel hub, to extend to a space between an outer wall of the lower shell and an outer peripheral surface of the circular columnar portion, and
the annular multipolar magnet is mounted to an inner peripheral surface of the skirt so as to face the outer peripheral surface of the circular columnar portion.

8. The cartridge tape according to claim 5, wherein the permanent magnet is embedded in the lock releasing member.

9. The cartridge tape according to claim 6, wherein the door member slides in a slide groove formed in the inner surfaces of the upper and lower shells, in a watertight state, and one end portion of the door member is contained in a shutter box provided on the inner surfaces of the upper and lower shells, in a watertight state, and
when the tape outlet is closed, the other end portion of the door member presses a portion of the magnetic tape between a leader pin for the magnetic tape and the reel hub against an inner surface of the casing in a watertight state.

10. The cartridge tape according to claim 9, wherein the other end portion of the door member presses a leader tape disposed between the leader pin and the magnetic tape, against the inner surface of the casing in a watertight state when the tape outlet is closed.

11. The cartridge tape according to claim 9, wherein the door member is entirely formed of a hard rubber member, or the door member includes rubber members in a portion which is contacted with the inner surfaces of the upper shell or the lower shell.

12. The cartridge tape according to claim 9, wherein the door member includes a sliding member that is curved in a circular arc shape, and a projection that is projected from an outer peripheral surface of the sliding member.

13. The cartridge tape according to claim 9, wherein the slide groove includes a circumferential groove, and
a space within the shutter box is curved in a circular arc shape having a radius substantially equal to a radius of the slide groove.

14. The cartridge tape according to claim 6, wherein a rotating shaft is disposed in a central portion of the lower shell to project therefrom, and
a central portion of the reel hub is attached to the rotating shaft with a bearing via the reel hub and the rotating shaft.

15. A drive device to drive a cartridge tape that contains a magnetic tape, the drive device comprising:
a ring-shaped yoke member:
a plurality of electromagnets installed on the yoke member at a certain interval; and
a control circuit to be able to energize s respective winding of the plurality of electromagnets,
the cartridge tape includes a reel hub disposed inside a casing,
the reel hub includes:
a cylindrical portion around which the magnetic tape is wound; and
an annular multipolar magnet to rotate the reel hub when a rotating magnetic field is applied outside a wall of the casing.

16. The drive device according to claim 15, wherein the control circuit generates a rotating magnetic field with respect to the annular multipolar magnet in the cartridge tape by successively energizing the individual electromagnets clockwise or counterclockwise.

17. The drive device according to claim 15, wherein the casing has a waterproof structure.

18. The drive device according to claim 15, wherein the casing includes a recess provided at a central portion of a bottom surface of the casing so as to form a circular columnar portion at the inner side and a circular recess at the outer side, and
the reel hub includes, at a position opposed to an outer peripheral surface of the circular columnar portion, a mounting portion to which the annular multipolar magnet is mounted.

19. The drive device according to claim 15, further comprising a permanent magnet installed inside the ring-shaped yoke member,
wherein the permanent magnet includes an S pole and an N pole in an axial direction of the yoke member, and
the permanent magnet is disposed so that one of the S pole and the N pole faces a reverse polarity of the annular multipolar magnet.
